(19) United States
(12) Patent Application Publication
(10) Pub. No.: US 2007/0094313 A1
(43) Pub. Date: Apr. 26, 2007

(54) Architecture and method for efficient bulk loading of a PATRICIA trie

(76) Inventor: Igor Bolotin, Sunnyvale, CA (US)

Correspondence Address: GLENN PATENT GROUP, 3475 EDISON WAY, SUITE L, MENLO PARK, CA, 94025, US

(21) Appl. No.: 11/258,456

(22) Filed: Oct. 24, 2005

(51) Int. Cl. G06F 17/30

(52) U.S. Cl. 707/205

(57) ABSTRACT

An apparatus and method for efficient bulk-loading of PATRICIA tries is disclosed. The trie is converted to its persistent representation prior to being written to an index block. Four arrays are used in the process of this conversion: a first is array used for the value nodes, a second array used for the inner nodes constituting a point-of-difference, a third array is used for storing parent pointers, and a fourth array is used for storing the running size of sub-tries. While creating the index nodes, the indexing system continuously attempts to determine the boundaries of the finished sub-tries. It also attempts to find the largest finished sub-trie that fits into a given size index block and, upon finding one, creates the persistent representation of the sub-trie and writes it into the index block.

### BACKGROUND OF THE INVENTION

1. Technical Field

The present invention relates generally to PATRICIA tries and more specifically, the invention relates to the efficient loading of the tries into a permanent storage medium.

2. Discussion of the Prior Art

Practical Algorithm To Retrieve Information Coded In Alphanumeric, or PATRICIA, is a trie shown by D. R. Morrison, in 1968. It is well-know in the art as a compact way for indexing, and is commonly used in databases as well as in networking applications. In a PATRICIA implementation, trie nodes that have only one child are eliminated. The remaining nodes are labeled with a character position number that indicates the nodes' depth in the uncompressed trie.

FIG. 1 shows an example of such an implementation of a PATRICIA trie for an alphabetical set. The words to be stored are ‘greenbeans,’ ‘greentea,’ ‘grass,’ ‘corn,’ and ‘cow’. The first three words differ from the last two words in the first letter, i.e. three begin with the letter ‘g,’ while the other two begin with the letter ‘c’. Hence, there is a difference at the first position. Therefore, there is a node at depth ‘0‘separating the ’ g’words from the ‘c’ words.

Moving on the ‘g’ side, the next time a difference is found is in the third position where two words have an ‘e,’ while one word has an ‘a.’ Therefore, a node at that level indicates a depth level of ‘2.’

Continuing down the left path reveals that the next time a different letter is found is at the sixth position where one word has a ‘b,’ while the other has a ‘t.’Therefore, there is a node at depth ‘5.’

One problem with this implementation is that keys are no longer uniquely specified by the search path. Hence, the key itself has to be stored in the appropriate leaf. An advantage of this PATRICIA implementation is that only about s*n bits of storage are required, where ‘s’ is the size of the alphabet and ‘n’ is the number of leaves.

An alphabet is a group of symbols, where the size of an alphabet is determined by the number of symbols in the group. That is, an alphabet having a s=2 is a binary alphabet having only two symbols, possibly ‘0’ and ‘1.’ FIG. 2 shows an implementation for such an alphabet. A binary alphabet makes it possible to overcome the restriction of storing only the string values in a trie because other data types may be represented as a string of bits.

A PATRICIA trie is either a leaf L(k) containing a key k or, a node N(d, l, r) containing a bit offset d≧0, along with a left sub-tree/and a right sub-tree r. This is a recursive description of the nodes of a PATRICIA tree, and leaves descending from a node N(d, l, r) must agree on the first d-1 bits. A description of PATRICIA tries may be found in A Compact B-Tree, by Bumbulis and Bowman, Proceedings of the 2002 ACM SIGMOD International Conference on Management of Data, pages 533-541, herein incorporated in its entirety by this reference thereto.

Using the PATRICIA trie architecture, a block of references may be prepared that point to the data stored in a permanent storage, for example disk-based data tables. It is a common practice in database systems to index large amounts of data in the so-called bulk-loading mode. Bulk-loading is defined as the process of building a disk-based index for an entire set of data without any intervening queries. Bulk-loading differs from multiple repeated inserts, because the build process is treated as a single indexing operation over the entire data set, and not as a set of atomic insert operations.

Bulk-loading is much more efficient than multiple inserts for a number of reasons: Bulk-loading has advantages for concurrency control because there is no locking on the index nodes. Bulk-loading is characterized by fewer input/output (I/O) operations during the index build resulting in a considerable speed-up of index creation. Additionally, the fill factor or use of the index blocks is much higher for the indexes created in the bulk-loading mode. Yet another advantage of the bulk-loading is the resulting sequential storage of data in the index blocks. These advantages make the bulk-loading of indexes in modern databases that use B-Trees as index structures a universally accepted approach for the efficient creation of indexes over large amounts of source data.

Known bulk-loading methods for B-Trees are not applicable for the PATRICIA tries because of their different tree structure and the resulting structure of the index blocks. A bulk-loading indexing solution for the PATRICIA tries is highly desirable for the systems that employ PATRICIA as the indexing structure. It would be therefore advantageous, due to the limitations of the prior art solutions, to provide an apparatus and method for the bulk-loading of a PATRICIA trie.

### SUMMARY OF THE INVENTION

An apparatus and method for efficient bulk-loading of PATRICIA tries is disclosed. The trie is converted to its persistent representation prior to being written to an index block. Four arrays are used in the process of this conversion: a first is array used for the value nodes, a second array used for the inner nodes constituting a point-of-difference, a third array is used for storing parent pointers, and a fourth array is used for storing the running size of sub-tries. While creating the index nodes, the indexing system continuously attempts to determine the boundaries of the finished sub-tries. It also attempts to find the largest finished sub-trie that fits into a given size index block and, upon finding one, creates the persistent representation of the sub-trie and writes it into the index block.

### BRIEF DESCRIPTION OF THE DRAWINGS

FIG. 1 shows a PATRICIA trie for an alphabetical case (prior art);

FIG. 2 shows a PATRICIA trie for a numerical case (prior art);

FIG. 3 shows a PATRICIA trie structure consisting of values and inner nodes;

FIG. 4 is a schematic diagram showing the arrays used in accordance with the invention;

FIG. 5 is a flowchart showing bulk-loading of a PATRICIA trie;

FIG. 6 is a schematic diagram showing loading of sub-tries of a PATRICIA trie into blocks of a storage medium; and

FIG. 7 is a schematic block diagram showing a system configured to enable bulk-loading of a PATRICIA trie.

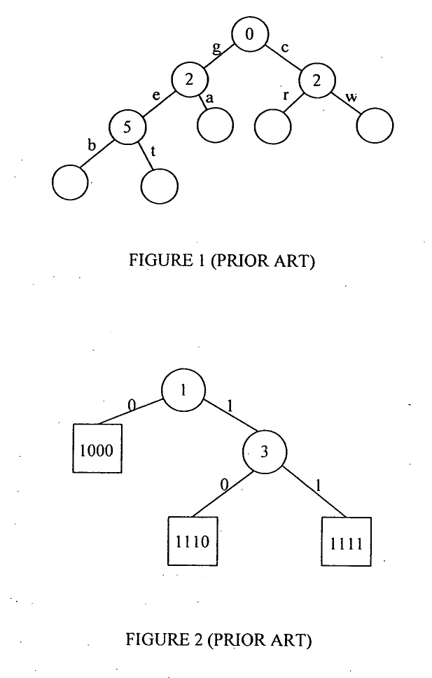

### DETAILED DESCRIPTION OF THE INVENTION

It is a common practice to store indexes in a permanent storage medium in blocks, similar to storing the files on disk in a file system. To optimize the reading of index blocks from a permanent storage, the blocks are of a fixed size that is usually aligned with the block size of the storage and operating system capabilities. Because an index block has a persistent representation, whereas a PATRICIA trie is a tree representation there is a need to have an apparatus and method for creating a persistent representation of the trie. The trie should then be converted to its persistent representation prior to being written to an index block. The conversion to the persistent representation is essentially a sequential arrangement of the trie nodes, while preserving the structure of the nodes in the original trie. The order of the nodes in a persistent trie representation is the result of a trie traversal algorithm. The nodes in a PATRICIA are traversed in a preorder. Such a traversal on a binary tree being defined as visiting the root first, then traversing the left sub-tree, and then traversing the right sub-tree.

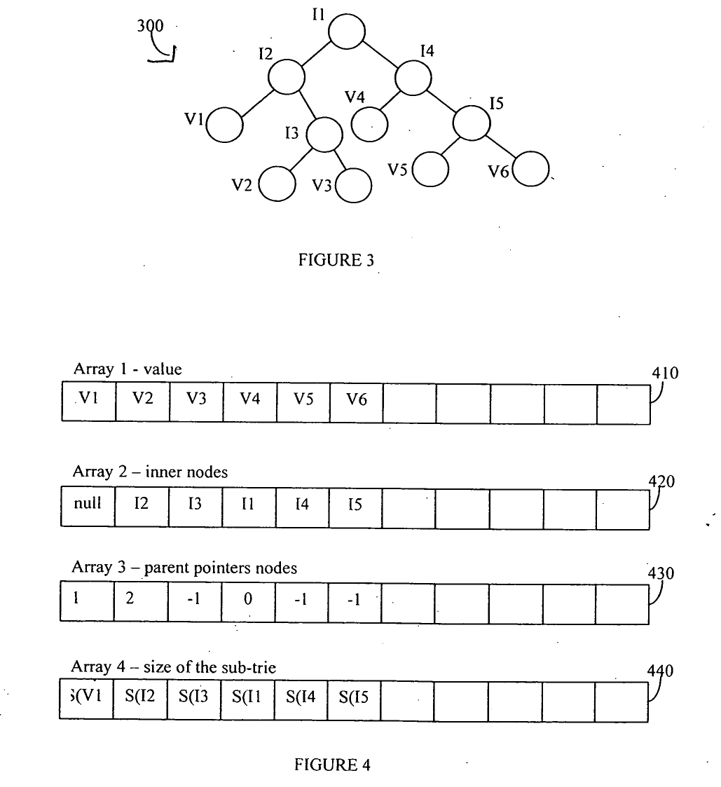

FIG. 3 that shows an exemplary PATRICIA trie. The PATRICIA trie comprises six leaf nodes, each containing a value V1 through V6, and five inner nodes I1 through I5, which contain positions of difference between the indexed values. It is necessary to perform a conversion from the PATRICIA structure to a liner representation. The result of the trie conversion into its linear representation is explained in more detail with reference to FIG. 4 below. Traversal begins at the root node, containing the value I1, then the node on the left is visited and hence, the node containing I2, and then the leaf node containing the value V1. Because this is a leaf node, no further traversal is necessary. The right leaf of I2 is now visited, having the value I3, causing the visit into first the left leaf containing the value V2, and then the right leaf containing the value V3, and so on until the entire PATRICIA trie is traversed.

For practical reasons, such as the finite amount of memory in the indexing system, it is not generally feasible to build a complete index trie in the memory, traverse it, and write the resulting persistent representation into the number of index blocks. Hence, the invention addresses avoiding the formation of a complete index trie while creating the index, and performing the processing on the index sub-tries limited and controllably allocated memory resources. A sub-trie is defined as a set of nodes consisting of an index node and all its descendant nodes, the sub-trie being smaller than the entire index trie.

In a preferred embodiment of the invention, the indexing system is supplied with the source index key data sorted in an ascending lexicographical order, and the system continuously reads the keys and creates index nodes corresponding to them until the source keys are exhausted. A person skilled in the art would readily note that because of the prefix compression inherent in a PATRICIA trie, the ascending sorting order guarantees that the sequence of the keys is aligned with the pre-order traversal of the trie, and the addition of a new node to a trie may occur only either above or to the right of the current node. An addition of a new node always happens in the same sub-trie as the last added node, unless the value in the first position of a key prefix changes compared to the last processed key. A sub-trie, where the last node was added, is finished when the next node to be inserted has a smaller position of difference than the last inserted node. All the sub-tries that comprise the finished sub-trie are finished as well.

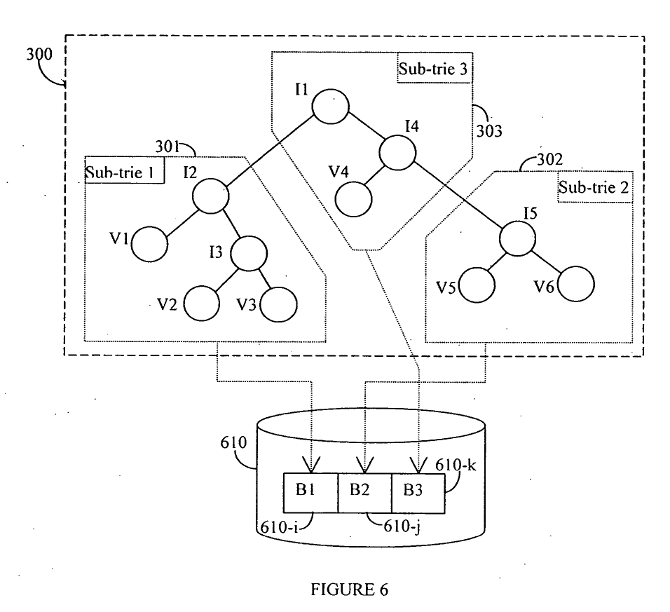

The indexing system continuously attempts to determine the boundaries of the finished sub-tries while creating the index nodes. It also attempts to find the largest finished sub-trie that fits into the index block of the given size and upon finding one, creates the persistent representation of the sub-trie and writes it into the index block. One goal in determining the largest sub-trie is maximizing index block use. As a result of the described algorithm, at any given point in time, there is no finished sub-trie in the system that is larger than an index block size. This is explained in more detail with reference FIG. 6 below.

In a preferred embodiment of the invention, the indexing system comprises an apparatus that comprises at least the four following data structures: an array for storing the values read from the sorted source keys, an array for storing the inner nodes, an array for storing the parent pointers for the inner nodes, and an array for storing the running size of the sub-tries. The size of the sub-trie is the sum of sizes of its nodes. FIG. 4 is a schematic diagram showing of the four arrays used in accordance with the invention. More specifically, the arrays are shown with content respective of the exemplary PATRICIA trie shown in FIG. 3. In the values array 410, the values of the nodes of the PATRICIA areas are placed in the order of traversal. Therefore, the first value to be placed in array 410 is ‘V1,’then ‘V2,’ and so on until the last value ‘V6.’In the inner nodes array 420, the inner nodes of the PATRICIA trie are placed in accordance with the order of traversal and, therefore, the order of the nodes is ‘I2,’ ‘I3,’ ‘I1,’ ‘I4,’ and so on. Notably, the node ‘I1’ appears at that position because traversal first reaches the node ‘I2,’ that has a leaf node, then goes to ‘I3,’ and stops there because of the leaf node. Only then is ‘I1’ is placed because only now the nodes ‘I2’ and ‘I3’ are considered leaves of that node.

The parent pointers to nodes array 430 contains distances between nodes in the arrays, from the current inner node to the parent inner node. Specifically, the formula notes that:
distance=parent_node_index−current_node_index (1)
Hence, for node V1 having an index=0 and its parent node 12, having an index=1, the distance is:
distance(V1)=1−0=1 (2)
For node I2, having an index=1 and having the parent node I1 having an index=3, the distance is:
distance(I1)=3−1=2 (3)
For node I2, having an index=1 and having the parent node I1 having an index=3, the distance is:
distance(I3)=1−2=−1 (4)
where the index is determined by the order of traversal. The values of this third array are used to facilitate fast navigation upwards in the PATRICIA trie, i.e. from leaf-to-root,

Lastly, the size of the sub-trie array 440 contains the size of each of the sub-tries identified. The information is n the arrays to allow for the efficient handling of the PATRICIA trie data for bulk-loading, thus allowing for the efficient handling of bulk-loading of the PATRICIA trie without having to use large portions of system memory, a resource that is generally in scarce availability and great demand. It is not necessary to have the array as large as the entire PATRICIA trie because, as noted above, there is a continuous attempt to identify sub-tries such that if one additional node is added to them they would no longer fit any more into a block of the storage medium. Loading such sub-tries into a respective block thereby frees array space.

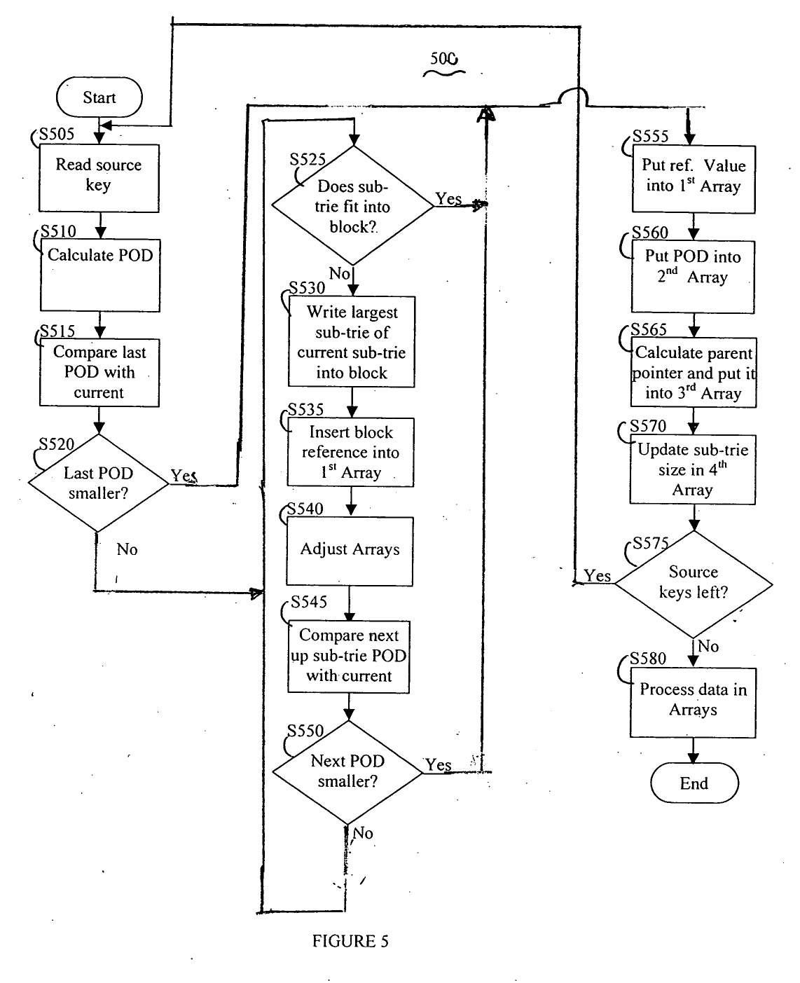

Several steps are required to achieve bulk-loading of a PATRICIA trie. The overall approach is first discussed and then, with respect to FIG. 5 a specific implementation is explained. The arrays discussed hereinabove are used in the following steps. Arrays 410 through 420 are filled with respective data based on keys read as an input from a PATRICIA trie representation of data. As the arrays are filled, sub-trie sizes are compared against the block size into which the sub-trie may be written. Once a block size threshold is passed, the immediately preceding sub-trie is written to the block of the storage medium. The values in the four arrays, i.e. arrays 410, 420, 430, and 440, that belong to the written sub-trie, are removed and the arrays are correspondingly adjusted, hence allowing the arrays to be significantly smaller than the overall size of the PATRICIA trie being handled. Processing then resumes from the beginning until all the source keys are processed. The data remaining in the arrays after the source data set is exhausted are processed sequentially in accordance with the algorithms described above and are written into the index blocks. Whatever nodes are left in the arrays when the method arrives to the root node are written as a root block of the persistent PATRICIA trie. A person skilled-in-the-art would note that both fixed size and variable size blocks may be used in conjunction with the disclosed invention.

FIG. 5 is a flowchart showing the steps for bulk-loading a PATRICIA trie as discussed hereinabove. The explanations herein below are made clearer with respect to FIGS. 3 and 4, as well as the general explanations provided above. In step S505, a source key is read and in step S510, the point of difference (POD) is calculated for the key. In step S515, a comparison takes place between the POD calculated in step S510 and the immediately previously calculated POD. In step S520, it is checked whether the pervious POD is larger than the current one and, if so, execution continues with step S555. Otherwise, execution continues with step S525. In step S525, it is checked whether the sub-trie fits into a block of the storage medium and if so execution continues with step S555. Otherwise, execution continues with step S530. In step S530, the largest sub-trie of the current sub-trie is written into a block. Then, in step S535 a reference to the block is inserted into the first array 410. In step S555, arrays are adjusted, i.e. the values in the arrays 410 through 420 are adjusted to reflect the fact that a sub-tire of the PATRICIA trie was written into a block. In step S545, the up sub-trie POD is compared with the current POD and in step S550, if it is determined that the next POD is small, then execution continues with step S555. Otherwise, execution continues with step S525.

Returning now to step S555, a reference value respective of the source key is put into the first array, for example, array 410. In step S560, the POD is placed into the second array, for example, array 420. In step S565, a pointer to the parent is calculated, as explained in more detail above, and inserted into the third array, for example array 430. In step S570, the fourth array, for example array 440, is updated with the size of the respective sub-tie. In step S575, it is checked if there are any source keys left, and if affirmative execution continues with step S505. Otherwise, execution continues with step S580 with the processing of the data in the arrays, i.e. completing the placement of the reminder of the nodes into a block of the storage medium, as explained in more detail above, before completion of the task.

FIG. 6 shows a PATRICIA trie 300 mapped into blocks of a storage medium 610 in accordance with the disclosed invention. As the PATRICIA trie is traversed and checked in accordance with the method described hereinabove, a sub-trie that fits into a block, for example block 610-i of storage medium 610, is found. When the largest sub-trie that fits into a block is found, it is written in its persistent representation into the block. Assuming now that sub-trie 301 of PATRICIA trie 300, that contains the nodes V1, V2, V3, 12, and 13, is the largest that fits into a block of storage medium 610, then that sub-trie 310 is mapped into a block, for example block 610-i. The next largest sub-trie found may be sub-trie 302 and it would be mapped into, for example, the consecutive block 610-j, and so on, thus achieving a goal of the invention, i.e. the bulk-loading of a PATRICIA trie into the fixed size blocks of a storage medium 610.

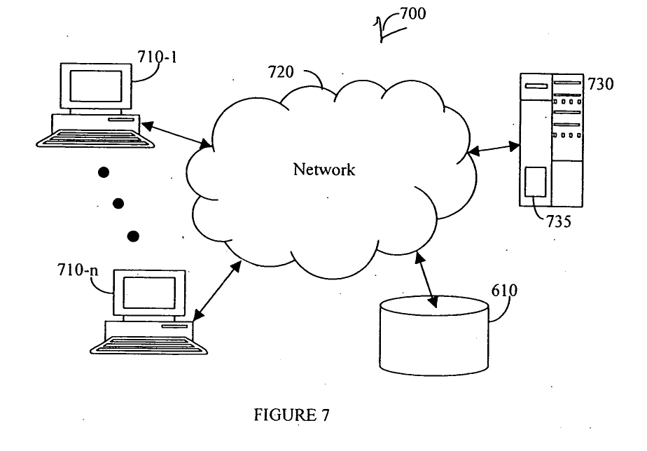

FIG. 7 shows a computer network having access to a database system enabling bulk-loading of a PATRICIA trie. The network comprises a plurality of access endpoints 710, including, but not limited to, personal computers (PCs), workstations (WSs), personal digital assistants (PDAs), and other means of network accessing devices, capable of or having a need to access a database. The devices are connected to a network 720, which is shown as a simple network for the purpose of simplicity. However, network 720 may be a local area network (LAN), wide area network (WAN), wireless network, and other types of networks, as well as all combinations thereof. Connected to the network is a server 730 containing at least a database management system (DBMS) 735, capable of performing the bulk-loading of a PATRICIA trie as disclosed in greater detail above. A storage medium 610 is connected to the system. Storage medium 610 may be a local means of storage, including being part of server 730, it may be a geographically distributed storage system, or it may be a combination thereof. A database system configured with the capabilities of bulk-loading of a PATRICIA trie, will enjoy the benefits of the invention disclosed herein, including significant performance improvement over prior art solutions, as described herein.

The disclosures of this invention may be further implemented in a computer software product, the computer software product containing a plurality of instructions that perform, when executed, the teachings herein.

Accordingly, although the invention has been described in detail with reference to a particular preferred embodiment, persons possessing ordinary skill in the art to which this invention pertains will appreciate that various modifications and enhancements may be made without departing from the spirit and scope of the claims that follow.

1. An apparatus for bulk-loading PATRICIA tries into a plurality of storage medium blocks, the architecture comprising:
a first array for to handling values from a PATRICIA trie;
a second array for handling information regarding inner nodes of said PATRICIA trie;
means for loading said first array and said second array with data from a set of source keys to be indexed; and
means for loading each of storage medium blocks with the largest available sub-tries of said PATRICIA trie.

2. The apparatus of claim 1, wherein the said set of source keys is sorted in an ascending order.

3. The apparatus of claim 1, wherein said means for loading said first and second arrays load said data in the same order as that of the keys in the said set of source keys.

4. The apparatus of claim 1, further comprising:
a third array for to handling pointers to parent nodes of sub-tries of said PATRICIA trie;
a fourth array for handling data that are the size of said sub-tries; and
means for computing values to be stored in said third array and said fourth array with data from said set of source keys to be indexed.

5. The apparatus of claim 4, said means for computing further comprising:
means for computing the pointers to parent nodes of sub-tries of PATRICIA trie and storing a result in said third array.

6. The apparatus of claim 4, said means for computing further comprising:
means for computing the size of sub-tries of said PATRICIA trie and for storing a result in said fourth array.

7. The apparatus of claim 4, further comprising:
means for using data in said third array to accelerate upwards navigation in said PATRICIA trie.

8. The apparatus of claim 1, wherein each of said storage medium blocks is one of fixed size and variable size.

9. The apparatus of claim 8, further comprising:
a database system.

10. A method for bulk-loading a PATRICIA trie into a plurality of storage medium blocks, comprising the steps of:
populating a first array with a plurality of node values of the PATRICIA trie that correspond to a set of source keys;
populating a second array with positions of difference between adjacent keys; and
determining that a collection of said PATRICIA trie nodes represented in the arrays constitute a largest sub-trie of said PATRICIA trie that fits into a single block of said storage medium;
writing said first array and said second array contents into an index block of storage medium.

11. The method of claim 12, wherein each said storage medium blocks is one of fixed size and variable size.

12. The method of claim 16, further comprising the steps of:
calculating parent pointers; and
populating said parent pointers in a third array.

13. The method of claim 10, further comprising the steps of:
calculating the size of sub-tries; and
populating said sizes of said sub-tries in a fourth array.

14. The method of claim 10, further comprising the step of:
removing data in said arrays that is respective of said largest sub-trie written into a block.

15. The method of claim 10, further comprising:
repeating the steps of claim 1 until all node values of said PATRICIA trie are written into said storage medium blocks.

16. The method of claim 10, further comprising the step of:
reading keys sequentially from said set of source keys until the end of said set of source keys is reached.

17. The method of claim 16, further comprising the step of:
populating said first array sequentially with data references corresponding to said source keys.

18. The method of claim 16, further comprising the step of:
populating said second array sequentially with the positions of difference between adjacent source keys.

19. The method of claim 18, wherein said determining the step further comprises the step of:
comparing a position of difference between a current position of difference and a previous position of difference in said second array.

20. The method of claim 19, wherein said determining step further comprises the step of:
continuing to read source keys if a current position of difference is larger than a previous position of difference in said second array.

21. The method of claim 19, wherein said determining step further comprises the step of:
initiating navigation up said PATRICIA trie a current position of difference is smaller than a previous position of difference in said second array.

22. The method of claim 21, wherein aid step navigating up said PATRICIA trie further comprises the step of:
using pointers to parent inner nodes in said third array.

23. The method of claim 21, wherein said step navigating setup said PATRICIA trie further comprises the step of:
stopping navigation up said PATRICIA trie when a position of difference smaller than that of a current position of difference is found.

24. The method of claim 18, wherein said determining step further comprises the step of:
removing data corresponding to a sub-trie written to said index block from said first array, said second array, said third array, and said fourth array.

25. The method of claim 24, wherein said determining step further comprises the step of:
adjusting data in said third array and said fourth array to reflect the changes in said first array and said second array.

26. The method of the claim 10, further comprising the step of:
writing remaining content of said first array and said second array into index blocks of said storage medium upon reaching the end of said source key data.

27. A computer software product containing a plurality of instructions for execution on a computer system, the plurality of instructions enabling bulk-loading of a PATRICIA trie into a plurality of fixed size blocks of a storage medium, said instruction comprising a method for executing the steps of:
populating a first array with a plurality of node values of a PATRICIA trie that correspond to a set of source keys;
populating a second array with positions of difference between adjacent keys; and
determining that a collection of nodes of said PATRICIA trie nodes represented in said first and second arrays constitute a largest sub-trie of said PATRICIA trie that fits a single block said storage medium; and
writing contents of said first array and said second array into an index block of storage medium.

28. The computer software product of claim 27, said method further comprising the step of:
calculating parent pointers; and
populating said parent pointers in a third array.

29. The computer software product of claim 27, said method further comprising the steps of:
calculating the size of sub-tries; and
populating said sizes of said sub-trie in a fourth array.

30. The computer software product of claim 27, said method further comprising the step of:
removing data in said arrays that are respective of said largest sub-trie written into a block.

31. The computer software product of claim 27, said method further comprising the step of:
repeating the steps of said method until all node values of said PATRICIA trie are written into blocks of said storage medium.
